(19) United States
(12) Patent Application Publication
(10) Pub. No.: US 2012/0069112 A1
(43) Pub. Date: Mar. 22, 2012

(54) INKJET RECORDING DEVICE

(75) Inventor: Akihisa WANIBE, Matsumoto (JP)

(73) Assignee: SEIKO EPSON CORPORATION, Tokyo (JP)

(21) Appl. No.: 13/232,051

(22) Filed: Sep. 14, 2011

(30) Foreign Application Priority Data
Sep. 22, 2010 (JP) 2010-212098

(51) Int. Cl. B41J 2/01

(52) U.S. Cl. 347/104

(57) ABSTRACT

An inkjet recording device includes: a medium feed part including a rotating body that rotates about a horizontal axis to feed an elongated recording medium while the recording medium is in contact against a circular outer face of the rotating body so that the recording medium is fed along an arcuate feed path conforming to the outer face; a medium recording part having a plurality of recording units arranged along the feed path, and that carries out recording through ejection deposition of ink onto the recording medium; an outfeed part that outfeeds the recording medium in a tangential direction from the rotating body at an outfeed position positioned in an upper half of the rotating body; and an ink fixation part facing from above the recording medium outfed from the rotating body, and fixes the ink that has been ejection-deposited onto the recording medium by the medium recording part.

### CROSS-REFERENCE TO RELATED APPLICATIONS

This application claims priority to Japanese Patent Application No. 2010-212098 filed on Sep. 22, 2010. The entire disclosure of Japanese Patent Application No. 2010-212098 is hereby incorporated herein by reference.

### BACKGROUND

1. Technical Field

The present invention relates to an inkjet recording device for carrying out a recording process on an elongated recording medium, such as paper or film, which is fed by making the medium conform about a rotating body.

2. Related Art

There is known in the art, in the field of inkjet recording devices, a device provided with a conveyor drum that rotates about a horizontal axis and conveys an elongated recording medium wound about its outside face, a plurality of printing sections of inkjet format disposed along the outside face of the conveyor drum, an infeed roller at the bottom of the conveyor drum, for infeeding the recording medium to the conveyor drum, and an outfeed roller at the bottom of the conveyor drum, for outfeeding the recording medium in a tangential direction from the conveyor drum, is (see Japanese Laid-Open Patent Application Publication No. 10-86472).

### SUMMARY

With this type of inkjet recording device, it may be contemplated to furnish ink fixation part for fixation of the ejected deposited ink. For example, in a case where an ultraviolet-curing ink is used as the ink, an ultraviolet irradiation device will be necessary for fixation of the ink through irradiation of the recorded image with ultraviolet. For reasons pertaining to gloss control, it is preferable that the ultraviolet irradiation device for curing the recorded image be disposed at a position a predetermined distance away to the downstream side in the feed direction from the printing sections. Thus, in the aforedescribed inkjet recording device, it may be contemplated to arrange the ink fixation part to face the recording medium at a point before the medium is fed out from the conveyor drum and reaches the outfeed roller.

However, with such a configuration, because the recording medium is fed out in a tangential direction from the bottom of the conveyor drum, the ink fixation part must be arranged so that the access face (e.g., the irradiation face of an ultraviolet irradiation device) is upward-facing so as to face toward the recorded face of the downward-facing recording medium. A problem encountered with an upward-facing access face is that particles and ink mist tend to become deposited on the access face from above, giving rise to defects of the ink fixation part. Also, because the configuration is one in which the ink fixation part is arranged below the recording medium, the recording medium positioned thereabove becomes heated by heat emitted by the ink fixation part. Specifically, damage to the recording medium by the heat of the ink fixation part was a problem.

An object of the present invention is to provide an inkjet recording device whereby ink fixation part can be arranged with the access face thereof facing downward, and arranged above the recording medium.

An inkjet recording device according to a first aspect of the present invention includes a medium feed part, a medium recording part, an outfeed part and an ink fixation part. The medium feed part includes a rotating body configured and arranged to rotate about a horizontal axis to feed an elongated recording medium while the recording medium is in contact against a circular outer face of the rotating body so that the recording medium is fed along an arcuate feed path conforming to the outer face. The medium recording part has a plurality of recording units arranged along the feed path, and configured and arranged to carry out recording through ejection deposition of ink onto the recording medium fed by the medium feed part. The outfeed part is configured and arranged to outfeed the recording medium in a tangential direction from the rotating body at an outfeed position positioned in an upper half of the rotating body. The ink fixation part faces from above the recording medium outfed from the rotating body, the ink fixation part configured and arranged to fix the ink that has been ejection-deposited onto the recording medium by the medium recording part.

According to this configuration, the recording medium is fed out in a tangential direction from the upper half of the rotating body, and the ink fixation part is arranged facing the outfed recording medium from above, whereby the recording medium can be outfed with the surface (recorded face) thereof to the upper side, whereby the ink fixation part can be arranged with the access face facing downward. For this reason, deposition of particles and ink mist onto the access face from above can be minimized. Also, because the ink fixation part can be arranged above the recording medium, heat emitted from the ink fixation part can escape upward so that the recording medium is not heated. Specifically, the recording medium is not damaged by the heat of the ink fixation part. Herein, “ink” refers to any ink requiring a fixation process, and may be an ink that undergoes fixation through drying of a solvent, or a thermal curing that undergoes thermal curing. Activating energy-curing type inks that are cured by activating energy such as ultraviolet are also acceptable.

According to another aspect of the present invention, the ink fixation part is preferably configured and arranged such that an arrangement position of the ink fixation part along the recording medium outfed by the outfeed part is changeable in a zone downstream from the outfeed position of the outfeed part.

According to this configuration, gloss control of the ejection-deposited ink can be carried out through modification of the arrangement position of the ink fixation part.

According to another aspect of the present invention, the device preferably further includes a preliminary ink fixation part arranged along the feed path, and configured and arranged to preliminarily fix the ink that has been ejection-deposited onto the recording medium. The preliminary ink fixation part is preferably arranged on the feed path in a preliminary fixation area positioned in a lower part of the rotating body, and the medium recording part is preferably arranged dispersed in recording areas positioned upstream and downstream of the preliminary fixation area.

It is a quality of recording units of inkjet design that if the direction of ejection is upward-facing, ejection deposition cannot take place with good accuracy, due to the effects of gravity.

In contrast to this, according to the aforedescribed configuration, the lower side of the rotating body serves as a preliminary fixation area where the preliminary ink fixation part is arranged, and the upstream and downstream sides thereof serve as recording areas where the recording units are arranged, whereby, in consideration of the aforedescribed quality of recording units, the units are not upward-facing, and moreover the recording units and the preliminary ink fixation part can be arranged with good space efficiency.

According to another aspect of the present invention, the medium recording part preferably has one or more underlayer recording units configured and arranged to eject and deposit an underlayer ink, and the one or more underlayer recording units are preferably arranged in the recording area positioned upstream of the preliminary fixation area.

According to this configuration, an underlayer ink recording process (ejection deposition) is carried out in the recording area at the upstream side, and after the underlayer ink has undergone preliminary fixation in the preliminary fixation area, the actual recording process is carried out. In so doing, color mixing between the underlayer ink and the ink of the actual recording process can be prevented, and a good quality recording result can be obtained.

According to another aspect of the present invention, the outfeed part is preferably configured and arranged to outfeed the recording medium in a horizontal direction from an upper end of the outer face.

According to this configuration, because the recording medium is outfed in a horizontal direction, the inkjet recording device need not be wider towards the top. Therefore, the space requirement of the inkjet recording device in the height direction can be reduced.

According to another aspect of the present invention, the device preferably further includes an infeed part configured and arranged to infeed the recording medium to the rotating body so that the recording medium is first fed along a direction of the outfeed path from the outer face by the outfeed part, and then an infeed direction of the recording medium is changed to a direction away from the outfeed position.

According to this configuration, after the recording medium has been fed along the outfeed path, the infeed part infeeds the medium to the rotating body, and therefore the space requirements of the inkjet recording device can be reduced further.

According to another aspect of the present invention, the infeed part is preferably disposed below the outfeed position.

According to this configuration, the space requirements of the inkjet recording device can be reduced, while making it possible for the ink fixation part to be arranged facing the outfed recording medium from above.

According to another aspect of the present invention, a line segment connecting a center of the rotating body and an infeed position at which the recording medium infed to the rotating body by the infeed part comes into contact with the rotating body, and a line segment connecting the outfeed position and the center of the rotating body preferably form an angle of less than 90 degrees.

According to this configuration, it is possible to further reduce the space requirements of the inkjet recording device.

According to another aspect of the present invention, the ink is preferably an activating-energy-curable ink, and the ink fixation part preferably has an energy beam irradiation device configured and arranged to irradiate the activating-energy-curable ink with an activating energy beam to cure the ink.

According to another aspect of the present invention, the activating-energy-curable ink is preferably an ultraviolet-curing ink, and the energy beam irradiation device is preferably configured and arranged to irradiate ultraviolet as the activating energy.

According to these configurations, the effect of minimizing damage to the recording medium can be achieved even in cases where an energy beam irradiation device that tends to emit heat is used. Also, an electron beam-curing ink, a radiation-curing ink, or an infrared-curing ink may be used as the “activating-energy-curable ink.”

An inkjet recording device according to another aspect of the present invention includes a medium feed part, a medium recording part, an ink fixation part and an infeed roller. The medium feed part includes a rotating body configured and arranged to rotate about a horizontal axis to feed an elongated recording medium while the recording medium is in contact against a circular outer face of the rotating body so that the recording medium is fed along an arcuate feed path conforming to the outer face. The medium recording part has a plurality of recording units arranged along the feed path, and configured and arranged to carry out recording through ejection deposition of ink onto the recording medium fed by the medium feed part. The ink fixation part faces the recording medium from above, and configured and arranged to fix the ink that has been ejection-deposited onto the recording medium by the medium recording part. The medium feed part and the infeed roller are configured and arranged such that the recording medium is outfed from an outfeed position positioned in an upper half of the rotating body in a first direction which is a tangential direction to the rotating body and a direction away from the rotating body, and the recording medium is guided in a second direction which is an opposite direction of the first direction and then directed via the infeed roller towards a direction away from the outfeed position to be infed to the infeed position positioned in the upper half of the rotating body.

According to this configuration, the space requirements of the inkjet recording device can be reduced, while making it possible for the ink fixation part to be arranged facing the outfed recording medium from above.

According to another aspect of the present invention, the infeed roller is preferably disposed below the outfeed position.

According to this configuration, it is possible to reduce the space requirements of the inkjet recording device.

According to another aspect of the present invention, the first direction is preferably along a horizontal direction.

According to this configuration, because the recording medium is outfed in a horizontal direction, the inkjet recording device need not be wider towards the top. Therefore, the space requirement of the inkjet recording device in the height direction can be reduced.

According to another aspect of the present invention, fixation of the ink by the ink fixation part preferably takes place subsequent to outfeeding of the recording medium from the outfeed position.

According to this configuration, because the ink fixation part can be arranged above the recording medium, heat emitted by the ink fixation part can escape upward, and does not heat the recording medium.

According to another aspect of the present invention, an unreeling reel, a windup reel, and an outfeed roller that are preferably configured and arranged such that the recording medium is guided in the second direction after being unreeled from the unreeling reel, and is redirected from the first direction via the outfeed roller after being outfed from the outfeed position and thereafter wound up by the windup reel.

According to this configuration, it is possible to reduce the space requirements of the inkjet recording device.

### BRIEF DESCRIPTION OF THE DRAWINGS

Referring now to the attached drawings which form a part of this original disclosure:

FIG. 1 is a front view depicting an inkjet recording device according to the present embodiment;

FIG. 2 is a front view of an inkjet recording device of a first modification example; and

FIG. 3 is a front view depicting a device main unit in an inkjet recording device of a second modification example.

### DETAILED DESCRIPTION OF EXEMPLARY EMBODIMENTS

An inkjet recording device according to an embodiment of the present invention is described below with reference to the accompanying drawings. This inkjet recording device is a recording device of center drum design having a plurality of head units disposed in a circumferential direction, and adapted to perform a printing process using ultraviolet-curing ink (UV ink) on an elongated recording medium supplied through a reel-to-reel arrangement. The recording medium is, for example, labeling film, or paper or the like of sheet form (so-called roll-fed paper); media of various different widths and thicknesses may be targeted for printing.

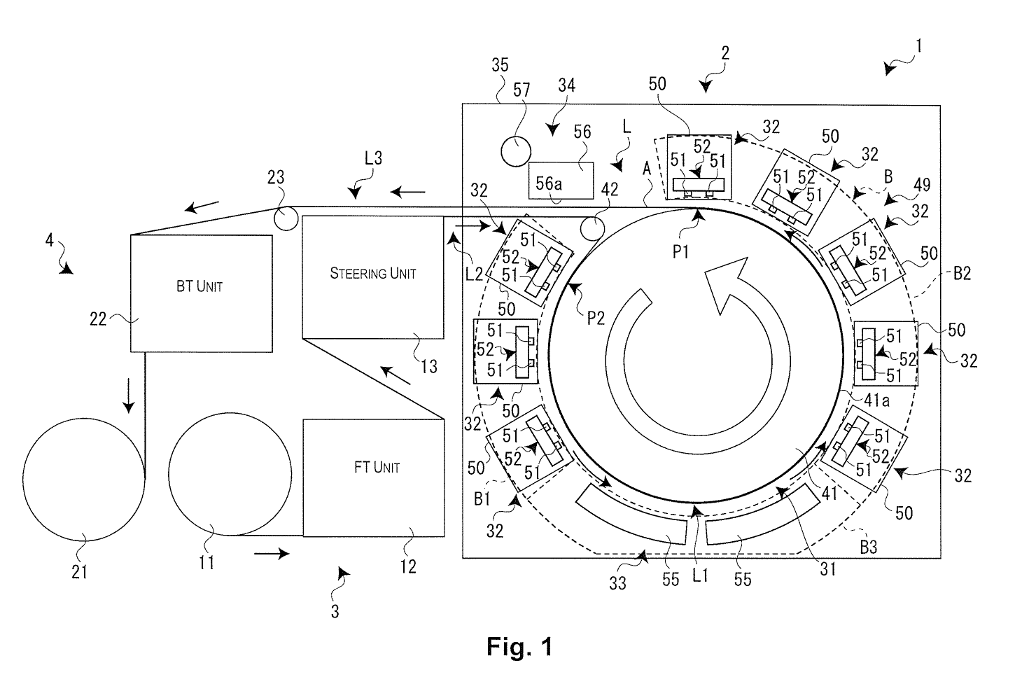

FIG. 1 is a model diagram depicting an inkjet recording device 1. In the description below, the right side in FIG. 1 is described as right, and the left side in FIG. 1 as left. As depicted in FIG. 1, the inkjet recording device 1 is provided with a device main unit 2 of center drum design for carrying out printing of a recording medium A; a medium supply device 3 for supplying the recording medium A to the device main unit 2; a medium recovery device 4 for recovering the printed recording medium A; and a control unit (not shown) for overall control of these constituent devices. The device main unit 2 print-feeds the recording medium A along an outer face 41a of a large-diameter rotating drum 41 adapted to feed the recording medium A having been placed in contact therewith. Specifically, a medium feed path L for the recording medium A, constituted by the device main unit 2, the medium supply device 3, and the medium recovery device 4, has a printing feed path (feed path) L1 of arcuate shape along the outer face 41a of the rotating drum 41, a supply feed path L2 for supply and infeed of the recording medium A to the rotating drum 41, and a recovery feed path (outfeed path) L3 for outfeed and recovery of the recording medium A from the rotating drum 41.

The medium supply device 3 is provided with an unreeling reel 11 for unreeling the recording medium A which has been wound into roll form; an unreeling motor (not shown) for powering unreeling rotation by the unreeling reel 11; a forward tension unit 12 arranged to the downstream side of the unreeling reel 11, for imparting forward tension to the recording medium A; and a steering unit 13 arranged to the downstream side of the forward tension unit 12, and adapted for positioning the recording medium A in the width direction and supplying it to the device main unit 2. The forward tension unit 12 is a tension unit of dancer roll design having a dancer roll and a pair of fixed rolls.

When the unreeling motor is driven in synchronization with the device main unit 2 by the control device, the recording medium A unreels from the unreeling reel 11. The unreeled recording medium A is fed along the supply feed path L2 while being imparted with a predetermined tension by the forward tension unit 12, and finally is supplied to the device main unit 2 while undergoing position correction in the width direction by the steering unit 13. As will be discussed in more detail later, the supplied recording medium A is infed to the rotating drum 41 at a diagonal upper right part thereof (an infeed position P2) via an infeed roller 42 of the device main unit 2. Here, the infeed position P2 is a position at which the infed recording medium A comes into contact with the outer face 41a of the rotating drum 41.

The medium recovery device 4 is provided with a windup reel 21 for winding the printed recording medium A into roll form; a windup motor (not shown) for powering windup rotation by the windup reel 21; a back tension unit 22 arranged to the upstream side of the windup reel 21, for imparting back tension to the recording medium A; and an outfeed roller (one example of an outfeed part) 23 arranged to the upstream side of the back tension unit 22, for outfeeding the recording medium A from the rotating drum 41. The back tension unit 22 is a tension unit of dancer roll design having a dancer roll and a pair of fixed rolls.

When the windup motor is driven in synchronization with the device main unit 2 by the control device, the recording medium A, while being imparted with predetermined tension by the back tension unit 22, is outfed from the rotating drum 41 and fed along the recovery feed path L3. The recording medium A outfed from the device main unit 2 passes the outfeed roller 23 and the back tension unit 22, and is wound up onto the windup reel 21. The recording medium A wound onto the windup reel 21 is then introduced into a device of another step, where cutting into labels or half-cutting into label segments is performed.

The outfeed roller 23 outfeeds the recording medium A along the recovery feed path L3, from the uppermost end of the rotating drum 41 (the outfeed position P1) towards the left side in a horizontal direction (first direction) which is a direction away from the rotating drum 41. Subsequently, the recording medium A is redirected and guided to the back tension unit 22. Here, the outfeed position P1 is a position at which the recording medium A previously contacting the outer face 41a of the rotating drum 41 separates from the outer face 41a of the rotating drum 41. Specifically, the configuration of the outfeed roller 23 is one adapted to outfeed the recording medium A in a tangential direction from the uppermost end of the rotating drum 41. As will be discussed in more detail later, a main curing unit 34 is arranged facing the recording medium A which has been outfed in the horizontal direction by the outfeed roller 23.

The device main unit 2 has a large-diameter rotating drum 41; a medium feed mechanism (one example of a medium feed part) 31 for feeding the recording medium A along the printing feed path L1; eight carriage units 32 in a radial arrangement with respect to the rotating drum 41 and having head units of inkjet design; a preliminary curing unit (one example of a preliminary ink fixation part) 33 facing the bottom of the rotating drum 41, for preliminary curing of ejection-deposited ultraviolet-curing ink; a main curing unit (one example of an ink fixation part) 34 facing the recording medium A outfed from the rotating drum 41, for main curing of ejection-deposited ultraviolet-curing ink; and a chamber 35 housing these in the interior thereof, for managing temperature and cleanliness. The eight head units installed in the eight carriage units constitute a printing part (one example of a medium recording part) 49 for carrying out a process on the recording medium A.

The recording medium A is outfed towards the left side by the outfeed roller 23 from an outfeed point P1 at the uppermost end of the rotating drum 41; and is infed from the left side by the infeed roller 42, discussed later, at an infeed point P2 at a position in proximity to the left side of the outfeed point P1 (the diagonal upper right part). A printing feed path L1 of arcuate shape extending around the entire outer face 41a of the rotating drum 41 is formed thereby, and a unit arrangement area B for the carriage units 32 and the preliminary curing unit 33 is established facing the entire outer face 41a.

The medium feed mechanism 31 is provided with the rotating drum 41 (rotating body) 41 formed with a traverse crown shape; a drum rotation mechanism (not shown) for rotating the rotating drum 41 about a horizontal axis; and an infeed roller (one example of an infeed part) 42 for infeeding the recording medium A to the rotating drum 41. The drum rotation mechanism is provided with a bearing for rotatably supporting the rotating drum 41 in cantilevered fashion via a drum shaft; a drum motor for causing the rotating drum 41 to rotate at low speed in one direction; and a belt drive power transmission mechanism intervening between the drum shaft and the drum motor (none of these are shown in the drawing). The drum motor is composed of a servo motor, for example, and rotates the rotating drum 41 such that the circumferential velocity at the outer face 41a of the rotating drum 41 is constant.

The outer face 41a of the rotating drum 41 is circular and has a width corresponding to the maximum width of the recording medium A. The outer face 41a has an antislip baked coating thereon. The recording medium A is thereby fed by the rotating drum 41 so as to describe a circle (arc) in contact with the outer face 41a of the antislip-treated rotating drum 41. Printing of the recording medium A is then carried out by appropriately driving the head units in synchronization with this feed.

The infeed roller 42 is arranged in proximity to the diagonal upper left side with respect to the rotating drum 41, guides the recording medium A along the supply feed path L2 from the steering unit 13 to the rotating drum 41 towards the right side in a horizontal direction (second direction) that is the opposite direction of the first direction, and thereafter redirects the medium in a direction away from the outfeed point P1 and infeeds it to the diagonal upper left part of the rotating drum 41 (the infeed point P2). The supply feed path L2 leading from the steering unit 13 to the infeed roller 42 is formed along the recovery feed path L3 leading from the rotating drum 41 to the outfeed roller 23, with the paths parallel to one another. Specifically, the configuration is one whereby the recording medium A is infed to the rotating drum 41 by the infeed roller 42 after having been fed along the recovery feed path L3 from the rotating drum 41 (the outer face 41a). The aforedescribed supply feed path L2 and recovery feed path L3 need not be completely parallel, and may be respectively inclined from the horizontal. Here, the infeed roller 42 is disposed below the outfeed point P1. The outfeed point P1 and the infeed point P2 are preferably positioned in the upper half side of the rotating drum 41, and in particular, in terms of reducing the space requirements of the inkjet recording device 1, it is preferable for a line segment connecting the center of the rotating drum 41 and the infeed position P2, and a line segment connecting the outfeed position P1 and the center of the rotating drum 41, to form an angle of less than 90 degrees.

The eight carriage units 32 are arranged radially along the printing feed path L1 with respect to the rotating drum 41, with their arrangement being divided between an upstream side recording area (recording area on the upstream side) B1 established in the left side part (the upstream side of the printing feed path L1) of the unit arrangement area B, and a downstream side recording area (recording area on the downstream side) B2 established in the left side to upper part (the downstream side of the printing feed path L1) of the unit arrangement area B. The eight carriage units 32 are units of separate ink colors respectively corresponding to three colors of ink for an underlayer (underlayer inks) and five colors of inks for actual printing, such as C (cyan), M (magenta), Y (yellow), and K (black). The three carriage units 32 of the three colors of ink for the underlayer are arranged in the upstream side recording area B1, while the five carriage units of the five colors of ink for actual printing are arranged in the downstream side recording area B2. Instead of the five inks for actual printing, carriage units 32 for inks of the four colors C, M, Y, K for actual printing and for one color of ink for finishing purposes may be arranged. In this instance, the carriage unit 32 of the ink for finishing purposes is arranged furthest downstream in the downstream side recording area B2.

Each of the carriage units 32 is provided with a carriage 50, a head unit (recording unit) 52 installed on the carriage 50 and carrying a plurality of inkjet heads 51, and a head control substrate module (not shown) for applying an ejection waveform to the plurality of inkjet heads 51. Each inkjet head 51 has two nozzle rows (not shown) parallel to one another on the nozzle face thereof. The plurality of inkjet heads 51 and the nozzle rows are arranged at offset positions in the nozzle row direction, with all of the nozzle rows of the plurality of inkjet heads 51 constituting a line head extending in the width direction of the recording medium A. Specifically, the head units 52 installed in the carriage units 32 of the different colors constitute line units of the different colors.

As mentioned above, the inks of the colors ejected by the inkjet heads 51 are combustible ultraviolet-curing inks which are cured by ultraviolet. The ultraviolet-curing inks (recorded image) ejection-deposited onto the recording medium A from the inkjet heads 51 undergo fixation (preliminary fixation or main fixation) onto the recording medium A by the preliminary curing unit 33 and the main curing unit 34.

The preliminary curing unit 33 has one or a plurality of preliminary curing UV lamps 55 for preliminary curing of the ultraviolet-curing inks, and is arranged in a preliminary curing area (preliminary fixation area) B3 established to the downstream side of the unit arrangement area B (the downstream side of the rotating drum 41: midway between upstream and downstream of the printing feed path L1). The preliminary curing unit 33, through the preliminary curing UV lamps 55 facing the outer face 41a, irradiates ultraviolet at an output appropriate for preliminary curing, and brings about preliminary curing (semi-curing) to an extent such that color mixing of the ultraviolet-curing inks (recorded image) ejection-deposited onto the recording medium A does not occur. Through preliminary curing of the underlayer inks which have been ejection-deposited to the upstream side of the preliminary curing area B3 (the upstream side recording area B1) in this way, color mixing between the underlayer inks and the actual recording inks can be prevented, and a good recorded result can be obtained.

The main curing unit 34 has a main curing UV lamp (energy beam irradiation device) 56 for main curing of the ultraviolet-curing inks, and a cooling duct 57 for a duct connection to cool the main curing UV lamp 56. The main curing UV lamp 56 is composed of a metal halide bulb, a mercury lamp, or the like; has an irradiation face 56a (access face) for irradiation of ultraviolet; and is adapted to irradiate ultraviolet at an output appropriate for main curing to bring about main curing of the ultraviolet-curing inks ere ejection-deposited onto the recording medium A.

The main curing UV lamp 56 is arranged to face from above the recording medium A outfed from the rotating drum 41, with the irradiation face 56a facing downward. Specifically, it is preferably arranged parallel to the recording face of the recording medium A, so that the irradiation face 56a is in opposition thereto.

Also, the main curing unit 34 may be configured such that the arrangement position thereof is modifiable along the outfed recording medium A, in a zone downstream from the outfeed position P1 of the recording medium A. In this case, through modification of the arrangement position of the main curing unit 34, the timing of curing of the ejection-deposited ink can be modified, and gloss control can be carried out. Further, a configuration in which, for example, the main curing unit 34 is provided with a slide mechanism providing slidable support along the outfed recording medium A so that the arrangement position of the main curing unit 34 may be modified, or a configuration provided with a unit movement mechanism for moving the main curing unit 34 along the outfed recording medium A, with the arrangement position of the main curing unit 34 being modified thereby, is acceptable as well.

With a configuration such as the above, by outfeeding the recording medium A in a tangential direction from the upper half part of the rotating drum 41, and arranging the main curing unit 34 to face the outfed recording medium A from above, the recording medium A can be outfed with the surface (recorded face) thereof to the upper side, whereby the irradiation face 56a of the main curing unit 34 can be arranged to face downward. Thus, deposition of particles or ink mist onto the irradiation face 56a from above can be minimized. Also, because the main curing unit 34 can be arranged above the recording medium A, heat emitted from the main curing unit 34 can escape upward so that the recording medium A is not heated. Specifically, the recording medium A is not damaged by the heat of the main curing unit 34. Further, because the main curing unit 34 can be arranged in the upper part of the device main unit 2, heat emitted by the main curing unit 34 can escape upward so that other constituent members are not heated.

Also, because the outfeed position P1 and the infeed position P2 are in proximity, the entire outer face 41a of the rotating drum 41 can be employed as the printing feed path L1. Because of this, the arrangement space facing the recording medium A on the outer face 41a (the unit arrangement area B) can be wider in proportion to the diameter of the rotating drum 41. Also, because the contact surface area with the recording medium A can be wider, slip (position shift with respect of the rotating drum 41) of the recording medium A can be effectively prevented.

Further, by employing the lower side of the rotating drum 41 as the preliminary curing area B3 where the preliminary curing unit 33 is arranged, and employing the upstream side and downstream side thereof as the recording areas B1, B2 where the carriage units 32 (head units 52) are arranged, the head units 52 need not face upward, and the carriage units 32 and the preliminary curing unit 33 can be arranged with good space efficiency.

Still further, because the recording medium A is outfed in a horizontal direction from the upper end of the outer face 41a, the inkjet recording device 1 need not be wider towards the top. Therefore, the space requirement of the inkjet recording device 1 in the height direction can be reduced.

Also, because the infeed roller 42 feeds the recording medium A on the supply feed path L2 lying along the recovery feed path L3 and thereafter infeeds it to the rotating drum 41, the space requirements of the inkjet recording device 1 can be reduced further.

In the aforedescribed embodiment, a metal halide lamp, a mercury lamp, or the like was used as the main curing UV lamp 56, but a configuration in which main curing is carried out using a UV LED lamp (ultraviolet light emitting diode lamp) is also acceptable.

Also, whereas the aforedescribed embodiment employed a configuration in which the main curing unit 34 is made to face the upstream end part of the recovery feed path L3, a configuration in which a main curing area for arranging the main curing unit 34 is established to face the entire zone of the feed path leading from the rotating drum 41 to the outfeed roller 23, and main curing is carried out throughout the entire zone of the feed path in question, is also acceptable. Likewise, a configuration in which a main curing area is established to face the entire zone of the feed path leading from the rotating drum 41 to the back tension unit 22 is also acceptable. In particular, by arranging a multitude of low-output UV LED lamps to face the entire zone of these feed paths, the cooling mechanism can be simplified.

### First Modification Example

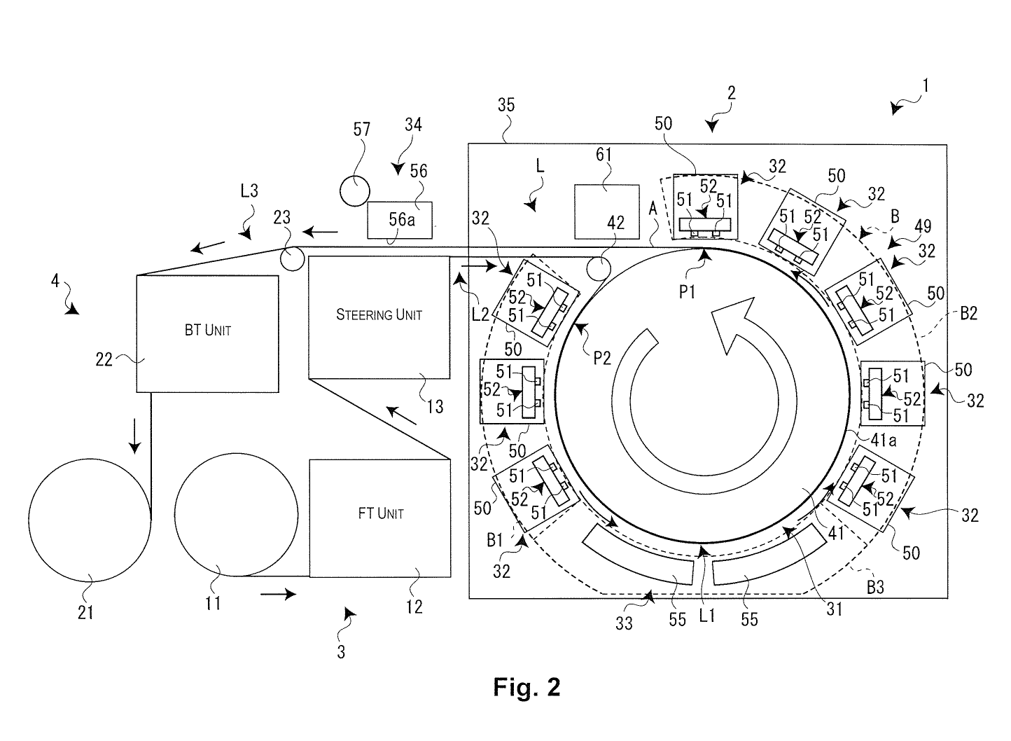

Also, whereas the aforedescribed embodiment configuration was one in which the main curing unit 34 is arranged facing the upstream end part of the recovery feed path L3, a configuration like that depicted in FIG. 2, in which a coating device 61 for coating a coating agent onto the recording medium A is arranged at this location, and the main curing unit 34 is arranged at a downstream position thereof, is also acceptable. In this case, the printed recording medium A can be coated over its entire surface by a simple configuration. The coating device 61 may be one of spray coater design, or one of roll coater design. Of course, one of inkjet design is also acceptable.

### Second Modification Example

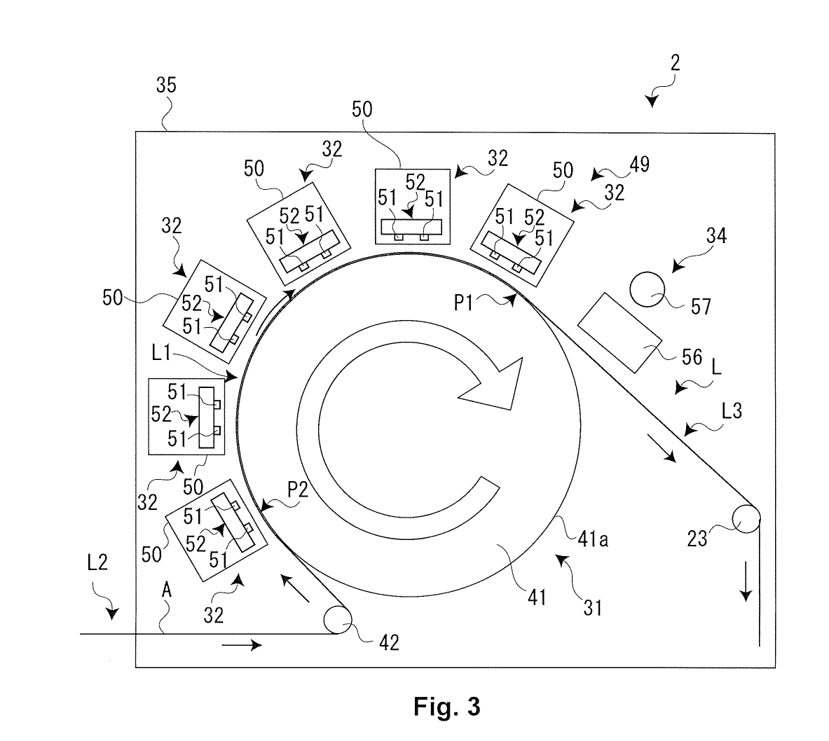

Further, whereas the aforedescribed embodiment configuration was one in which the recording medium A is outfed in the horizontal direction from the uppermost end by the outfeed roller 23, and the recording medium A is infed at an infeed position P2 in proximity to the outfeed position P1, such a configuration is not given by way of limitation, provided that the configuration is one of outfeed in a tangential direction from the upper half part of the rotating drum 41. For example, as depicted in FIG. 3, a configuration in which the outfeed position P1 is at the diagonal upper right part, the recording medium A is outfed in a tangential direction (downward diagonally to the right) from that outfeed position P1, and the recording medium A is infed to the infeed position P2 in the diagonal lower left part is also acceptable.

Still further, whereas in the aforedescribed embodiment, the printing process was carried out using ultraviolet-curing ink, any activating-energy-curable ink that is cured by activating energy, for example, infrared-curing ink, electron beam-curing ink, radiation-curing ink, or the like may be used. Hence, if the ink is one requiring a fixation process, the ink may be one that is fixed by drying of a solvent, or a thermal-curing ink that thermally cures. In this case, ink fixation part corresponding to the ink will be used.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An inkjet recording device comprising:
a medium feed part including a rotating body configured and arranged to rotate about a horizontal axis to feed an elongated recording medium while the recording medium is in contact against a circular outer face of the rotating body so that the recording medium is fed along an arcuate feed path conforming to the outer face;
a medium recording part having a plurality of recording units arranged along the feed path, and configured and arranged to carry out recording through ejection deposition of ink onto the recording medium fed by the medium feed part;
an outfeed part configured and arranged to outfeed the recording medium in a tangential direction from the rotating body at an outfeed position positioned in an upper half of the rotating body; and
an ink fixation part facing from above the recording medium outfed from the rotating body, the ink fixation part configured and arranged to fix the ink that has been ejection-deposited onto the recording medium by the medium recording part.

2. The inkjet recording device according to claim 1, wherein
the ink fixation part is configured and arranged such that an arrangement position of the ink fixation part along the recording medium outfed by the outfeed part is changeable in a zone downstream from the outfeed position of the outfeed part.

3. The inkjet recording device according to claim 1, further comprising
a preliminary ink fixation part arranged along the feed path, and configured and arranged to preliminarily fix the ink that has been ejection-deposited onto the recording medium,
the preliminary ink fixation part is arranged on the feed path in a preliminary fixation area positioned in a lower part of the rotating body, and
the medium recording part is arranged dispersed in recording areas positioned upstream and downstream of the preliminary fixation area.

4. The inkjet recording device according to claim 3, wherein
the medium recording part has one or more underlayer recording units configured and arranged to eject and deposit an underlayer ink, and
the one or more underlayer recording units are arranged in the recording area positioned upstream of the preliminary fixation area.

5. The inkjet recording device according to claim 1, wherein
the outfeed part is configured and arranged to outfeed the recording medium in a horizontal direction from an upper end of the outer face.

6. The inkjet recording device according to claim 1, further comprising
an infeed part configured and arranged to infeed the recording medium to the rotating body so that the recording medium is first fed along a direction of the outfeed path from the outer face by the outfeed part, and then an infeed direction of the recording medium is changed to a direction away from the outfeed position.

7. The inkjet recording device according to claim 6, wherein
the infeed part is disposed below the outfeed position.

8. The inkjet recording device according to claim 6, wherein
a line segment connecting a center of the rotating body and an infeed position at which the recording medium infed to the rotating body by the infeed part comes into contact with the rotating body, and a line segment connecting the outfeed position and the center of the rotating body form an angle of less than 90 degrees.

9. The inkjet recording device according to claim 1, wherein
the ink is an activating-energy-curable ink, and
the ink fixation part has an energy beam irradiation device configured and arranged to irradiate the activating-energy-curable ink with an activating energy beam to cure the ink.

10. The inkjet recording device according to claim 9, wherein
the activating-energy-curable ink is an ultraviolet-curing ink, and
the energy beam irradiation device is configured and arranged to irradiate ultraviolet as the activating energy.

11. An inkjet recording device comprising:
a medium feed part including a rotating body configured and arranged to rotate about a horizontal axis to feed an elongated recording medium while the recording medium is in contact against a circular outer face of the rotating body so that the recording medium is fed along an arcuate feed path conforming to the outer face;
a medium recording part having a plurality of recording units arranged along the feed path, and configured and arranged to carry out recording through ejection deposition of ink onto the recording medium fed by the medium feed part;
an ink fixation part facing the recording medium from above, and configured and arranged to fix the ink that has been ejection-deposited onto the recording medium by the medium recording part; and
an infeed roller,
the medium feed part and the infeed roller being configured and arranged such that the recording medium is outfed from an outfeed position positioned in an upper half of the rotating body in a first direction which is a tangential direction to the rotating body and a direction away from the rotating body, and the recording medium is guided in a second direction which is an opposite direction of the first direction and then directed via the infeed roller towards a direction away from the outfeed position to be infed to the infeed position positioned in the upper half of the rotating body.

12. The inkjet recording device according to claim 11, wherein
the infeed roller is disposed below the outfeed position.

13. The inkjet recording device according to claim 11, wherein
the first direction is along a horizontal direction.

14. The inkjet recording device according to claim 11, wherein
fixation of the ink by the ink fixation part takes place subsequent to outfeeding of the recording medium from the outfeed position.

15. The inkjet recording device according to claim 11, further comprising
an unreeling reel, a windup reel, and an outfeed roller that are configured and arranged such that the recording medium is guided in the second direction after being unreeled from the unreeling reel, and is redirected from the first direction via the outfeed roller after being outfed from the outfeed position and thereafter wound up by the windup reel.
